(19) United States
(12) Patent Application Publication
(10) Pub. No.: US 2021/0133663 A1
(43) Pub. Date: May 6, 2021

(54) MARKET EQUILIBRIUM MECHANISM FOR TASK ALLOCATION

(71) Applicant: B.G. NEGEV TECHNOLOGIES AND APPLICATIONS LTD., AT BEN-GURION UNIVERSITY, Beer Sheva (IL)

(72) Inventors: Roie ZIVAN, Meitar (IL); Sofia AMADOR, Kiryat Ono (IL)

(21) Appl. No.: 16/491,721

(22) PCT Filed: Mar. 7, 2018
(86) PCT No.: PCT/IL2018/050263

§ 371 Date: Sep. 6, 2019

Related U.S. Application Data
(60) Provisional application No. 62/467,843, filed on Mar. 7, 2017.

(51) Int. Cl. G06Q 10/06; G06Q 10/10

(52) U.S. Cl. CPC G06Q 10/063116; G06Q 50/26; G06Q 10/1097; G06Q 10/063112

(57) ABSTRACT

Systems and methods are provided for allocating and scheduling tasks to agents, according to a process that includes: assigning to each agent a plurality of tasks, by a simulated auction process comprising calculating agent-task utility values, wherein the agent-task utility values are calculated from the parameters including a delayed start penalty, a task interruption penalty, and an agent contribution function; generating a schedule of the assigned plurality of tasks for each agent, by ranking the assigned plurality of tasks according to a utility ranking; and changing an order of assigned tasks of a schedule of at least one agent, to coordinate a start time of a shared task performed by multiple agents.

### FIELD OF THE INVENTION

The present invention is directed to systems and methods for optimizing activities within an enterprise, and particularly for real-time scheduling of agent tasks performed at dispersed geographic sites.

### BACKGROUND

Realistic multi-agent task scheduling often requires a fast decision-making process that can cope with rapidly changing events. Emergency-response and law enforcement scenarios are among the most serious applications that may require task scheduling. In these situations, if agents do not react quickly, lives may be lost, property damaged, and as in the case of a fire, the problem can get much worse if it is not attended quickly. In other types of environments, response teams may not deal with life threatening situations, but may still need to be deployed quickly as new incidents are reported.

In such applications one must take into consideration spatial and temporal constraints, e.g., an agent's physical distance from a task's location, and the task that the agent is currently assigned to (and may be required to interrupt). While these dynamic and unpredictable scenarios require fast decision making on the allocation of events to law enforcement or rescue units, the optimization problems at hand are often hard problems that require exhaustive search in order to find the optimal allocation. The conflict between the need for a timely decision and the hard complexity of full optimization leads to a requirement for design approximation algorithms that can produce high quality solutions in a short time.

An assignment of tasks to agents is a solution to what may be called a “Law Enforcement Problem” (LEP), as described by Amador et al. [1], whose disclosure is expressly incorporated herein by reference, in its entirety.

### SUMMARY

It is an object of the present invention to provide a system and method for allocating and scheduling tasks at dispersed physical locations to agents.

Embodiments of the present invention provide a computing system, having at least one processor and at least one memory storage, the memory storage communicatively coupled to the processor, on which is stored computer-readable instructions that when executed by the processor cause the computing system to perform a method for allocation and scheduling of tasks including: receiving an agent list of agents, wherein each agent in the list is associated with a first geographic location and with a skill set; receiving a task list, wherein each task is associated with one or more skill requirements, a second geographic location, and parameters of a task utility function; assigning to each agent a plurality of tasks from the task list, by a simulated auction process comprising calculating an agent-task utility value, wherein the agent-task utility values are calculated from the parameters of the task utility functions, including a delayed start penalty, a task interruption penalty, and an agent contribution function; generating a schedule of the assigned plurality of tasks for each agent, by ranking the assigned plurality of tasks according to a utility ranking; and changing an order of assigned tasks of a schedule of at least one agent, to coordinate a start time of a shared task performed by multiple agents.

In some embodiments, assigning to each agent the plurality of tasks may include assigning a given task to a given agent only if the skill set of the given agent includes a required skill of the given task. In further embodiments, the utility ranking, for a given task assigned to a given agent, equals an agent-task utility value, for the given task assigned to the given agent, divided by the given agent's portion of a workload of the given task (i.e., a “bang for buck” ratio, as described further hereinbelow).

The delayed start penalty may be a function of a difference between a start time of a given task and a time that a notification of the task was received by the computing system. The task interruption penalty of an agent utility may be a function of a predefined interruption penalty factor of a current task and an amount of work performed by the given agent. The contribution function may be the maximum contribution a given agent provides to the utility of a given task, assuming an optimal assignment of agents to the given task.

In some embodiments, In additional embodiments, changing an order of assigned tasks of the schedule of the at least one agent comprises a distributed process, comprising sending from each of the multiple agents to each of the other multiple agents a notification of an earliest time of arrival to the shared task; and wherein each of the multiple agents determines the start time for the shared task as the latest time of all the earliest times.

The method for allocation and scheduling of tasks may execute on the one or more processors in polynomial time.

In some embodiments, the agent-task utility values are determined by concave, exponential functions, wherein the exponents of the functions are greater than 0 and less than 1, such that the simulated auction assigns more shared tasks to the agents than when the agent-task utility values are determined by linear functions. The exponents of the functions may be set according to a need for cooperation on a task.

There is also providing, by embodiments of the present invention, a computer-based method for allocating and scheduling tasks, implemented by at least one processor having at least one memory storage on which is stored computer-readable instructions, which, when executed by the processor, cause the computing system to perform the method including: receiving an agent list, wherein each agent is associated with a first geographic location and with a skill set; receiving a task list, wherein each task is associated with one or more skill requirements, a second geographic location, and parameters of a task utility function; assigning to each agent a plurality of tasks from the task list, by a simulated auction process comprising calculating an agent-task utility value, wherein the agent-task utility values are calculated from the parameters of the task utility functions, including a delayed start penalty, a task interruption penalty, and an agent contribution function; generating a schedule of the assigned plurality of tasks for each agent, by ranking the assigned plurality of tasks according to a utility ranking; and changing an order of assigned tasks of a schedule of at least one agent, to coordinate a start time of a shared task performed by multiple agents.

### BRIEF DESCRIPTION OF DRAWINGS

In the following detailed description of various embodiments, reference is made to the following drawings that form a part thereof, and in which are shown by way of illustration specific embodiments by which the invention may be practiced, wherein:

FIG. 1 is a schematic, pictorial illustration of a system in which agents are assigned to tasks by a two stage heuristic scheduling process, in accordance with an embodiment of the present invention; and

FIG. 2 shows a flowchart of a process for real-time assignment of agents to tasks by a two stage heuristic scheduling process, in accordance with an embodiment of the present invention.

### DETAILED DESCRIPTION OF THE INVENTION

In the following detailed description of various embodiments, it is understood that other embodiments may be utilized and structural changes may be made without departing from the scope of the present invention.

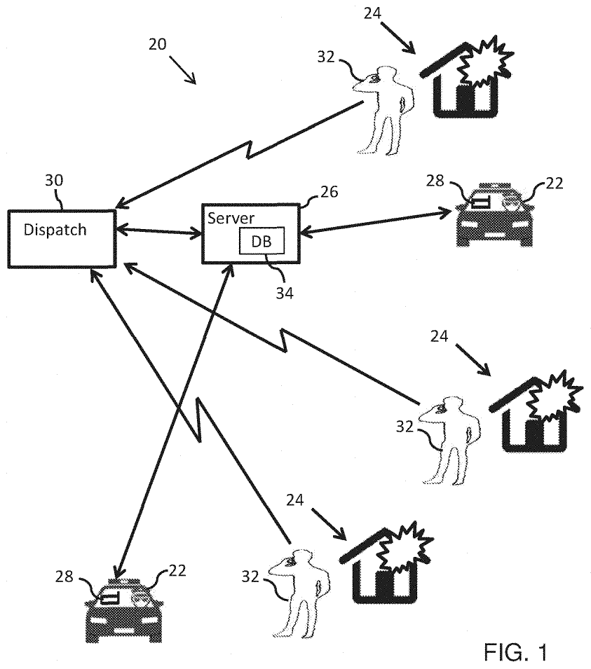

FIG. 1 shows a schematic, pictorial illustration of a system 20 in which agents 22 are assigned to tasks 24 by a heuristic assignment and scheduling process, in accordance with an embodiment of the present invention. The system is typically implemented for the benefit of an organization employing the agents, such as a police, fire, or rescue service. Organizations may also be large industrial or civilian settings, such as airports, hospitals, or factories. Agents are typically emergency or service responders of those organizations, such as law enforcement officers, military units, firefighters or other service individuals or crews. Hereinbelow, a unit or crew that travels together from task to task and is assigned as a single unit is also referred to as an agent. The set of all agents currently allocated to tasks may be referred to as a “shift”. A group of agents assigned to a single task is referred to hereinbelow as a “team”.

For organizations implementing the system, the goal is typically to assign and schedule tasks in an optimal manner, within a time constraint dictated by the urgency of the service response environment. In some embodiments, agents have heterogeneous capabilities, that is, not all have the same set of skills, that is, competencies to perform certain types of work. Similarly, tasks may be defined as requiring a variety of skills.

Two types of tasks may be distinguished. Tasks may be specific incidents, that is, “events”, also referred to hereinbelow as “incident tasks”, meaning tasks that are reported or initiated on an ad hoc basis. Alternatively, tasks may be pre-scheduled work, such as patrol work, that is, work that does not include responding to specific, reported incidents. A task assignment process, described further hereinbelow, is dynamic in that the process is typically repeated as new incidents are reported.

The heuristic scheduling process of the present invention may be implemented by one or more computing devices, and may be a centralized or distributed process. In a centralized process, the implementation may be performed by a server 26. In a distributed process, some or all of the required processing steps may be implemented by distributed processes, which may execute on distributed computing devices, such as mobile devices 28. As indicated, the mobile devices 28 may be associated with respective agents, either as vehicle-based computing devices or as agent-operated smartphones.

The tasks 24 that are ad hoc, rather than pre-scheduled, are typically reported (i.e., “called in”) to a central dispatch or “hot-line” center 30. Incidents are generally reported to the hot-line by callers 32 who are in the vicinity of the incidents. Callers may be human or automated alarm systems. When such a notification of an incident is received, the incident is entered to server 26 together with associated information, such as a geographic location. The geographic data may be entered manually, by operators at the center, or automatically by a transmission of GPS details from the callers. Operators at the hot-line may then categorize the reported incidents, according to a level of importance and/or an incident template. In the case of automated callers, such as fire alarms, the categorization and/or level of importance may also be set automatically.

The process of categorization assigns task parameters to each incident. Task parameters may include factors that indicate a relative utility of accomplishing the task, which may also be a function of the number of agents assigned and the types of skills required. Task parameters may also include an estimated time for accomplishing the task, penalty factors for delaying or interrupting a task, and a required number of agents to assign, which may be a range of numbers. Incidents may also require several specific skills, meaning that only agents having the specific skill subset can be assigned.

Each newly reported incident may trigger execution of the heuristic scheduling process. As described further hereinbelow, task parameters and agent parameters may be recorded to, and maintained by, memory storage of the server 26, indicated as database 34. The database 34 may also be communicatively associated, additionally or alternatively, with the mobile devices 28, either locally and/or remotely.

The server 26 may also receive geographic locations and additional parameters of incidents 24 from the dispatch center 30. Agents are provided with a means for tracking their own physical locations, for example by means of GPS capabilities of the mobile devices 28. In some embodiments, the mobile devices 28 are also configured to transmit agent locations to the server 26.

Heuristic Scheduling Process

The heuristic scheduling process of the present invention proceeds in two stages. The first stage assigns a set of m real-time tasks v₁, v₂, v₃, . . . vₘ to n agents, a₁, a₂, a₃, . . . aₙ. The assignment of tasks to agents may be represented by an n×m “assignment matrix” X, where each entry xᵢⱼ of the matrix represents the fraction of a task vⱼ that is assigned to an agent aᵢ. A fraction of a task vⱼ may indicate a percentage of a total task worktime allocated to the agent. As described above, several tasks may be identified at a single location, each task requiring a different skill set.

A market clearing algorithm, described further hereinbelow, is employed by the first stage of the present invention to assign tasks to agents. The algorithm makes assignments based on a calculation of a potential contribution of each agent to each task. The result is an unordered list of task assignments for each agent. A “market clearing solution”, is described in references Brainard [2], Davanur et al. [3], Gale [4], Reijnierse and Potters [5], and Zhang [6], whose disclosures are expressly incorporated herein by reference, in their entirety.

The second stage of the heuristic scheduling process generates agent schedules from the unordered lists, that is, the second stage provides an ordering of agent tasks. In mathematical terms, a schedule of tasks of an agent aᵢ is an ordered list of Mᵢ triples, where each task performed by an agent aᵢ is also associated with a start time tⁱ and an end time tⁱ′. A schedule of an agent a₁ may therefore be defined as a list of terms σⁱ having the form:

σⁱ=(vₛ_{₁}_{ⁱ},t₁ⁱ,t₁ⁱ′), . . . ,(vₛ_{_{Mi}}_{ⁱ},t_{Mi}ⁱ,t_{Mi}ⁱ′) (1)

The process provided by the present invention is understood to be a heuristic for achieving a high aggregate utility of task completion, that is, it is a heuristic designed to execute quickly and to achieve a high level of aggregate utility, without testing all possible combinations of tasks assignments. The concept of aggregate utility may be viewed as representing a measure of social welfare provided by the agents through the performance of tasks.

### Task Parameters

New incidents are generally categorized, or classified, based on pre-defined classification rules or templates. For example, a classification method may include assigning an “importance rating”, I(v), to a task. Levels of importance, pre-defined as importance rating scores, may also be associated with different “task utility functions”, U(v). When an incident is reported to the hot-line, the incident may be assigned an importance rating or may be classified as a generic type of incident, in order to facilitate the association of the task with a utility function, described further hereinbelow.

Incidents are also assigned a workload w(v), specifying how much work (in time units, e.g., man-hours) will likely be performed to complete the task (for example, securing a crime scene or taking statements). Patrols, i.e., pre-scheduled tasks, have no workload but as they are considered ongoing tasks, the performance of which has a positive utility that accumulates at a constant rate. Patrol tasks are generally less important than “incident” tasks per unit of time.

Multiple agents can be assigned to a single task. At least one of the agents sharing a task must be present before task execution can begin, and the amount of time an agent spends on the task is equal to the agent's allocated fraction of the workload xᵢⱼ w(v). The allocation fractions may be different for different agents.

The amount of time an agent spends on a task (i.e., the end time of the agent's share of a task minus the start time) equals an agent's assigned share of the workload w(vₖ). There is also a “travel time” ρ between a geographic location of a first task and a geographic location of a second task, which is less than or equal to the difference between the time that an agent ends work on one task and starts the next task. These constraints are described mathematically, referring to the syntax of the scheduled lists described above, by the following equations:

tₖ^{i′}−tₖⁱ=xᵢₛ_{ₖ}_{ⁱ}w(vₛ_{ₖ}_{ⁱ}) 1≤k≤Mi (2)

tₖ₊₁ⁱ−tₖ′≥ρ(vₛ_{ₖ}_{ⁱ},vₛ_{ₖ₊₁}_{ⁱ}) 1≤k≤Mi (3)

A “task start time” is the time that one or more agents begin to perform a task and is denoted as t(vⱼ). A task may be defined as requiring two or more agents to be present at the start time, though agents may not actually arrive at the site of a task at the exact same moment. Alternatively, a task may be shared but not require all agents to arrive sharing the task to start at the same time. It may be noted that one agent does generally arrive at a task before others. In mathematical terms, for all vⱼ∈V (the set of all tasks) there exists a time t(vⱼ), such that for all aᵢ ∈A:

vⱼ=vₛ_{ₖ}_{ⁱ}⇒t(vⱼ)=min{tₖ_{ᵢ}} (4)

An agent utility function, or “agent contribution” function, for each agent working on a task vⱼ may be denoted by Cap(vⱼ, q). This function generates a “utility value” based on an agent's capacity for “generating” utility through the performance of the task. The function may also reflect a requirement that a task have a minimum required number of agents or a maximum allowed numbers of agents. That is, the Cap function may be defined as equal to 0 for fewer than the minimum or for more than the maximum number of agents, respectively. The Cap function may also be set to indicate a synergistic effect or a cost of multiple agents working together. In some embodiments, the Cap function may be defined as increasing for each agent, up to a maximum number of agents Qᵥ. The maximum value of the capability function, when Qᵥ agents are assigned, may be set to equal the “importance rating”, according to the following equation:

Cap(v,q)=min{(q/Qᵥ)I(v),I(v)} (5)

Delaying the start of work on a task may mean that perpetrators of a crime may escape, or that confrontations may escalate. In some embodiments, a “delayed start” penalty reduces the utility that a team assigned to the same task would achieve by starting the task immediately when a notification of the task is received. function δ may be a declining exponential function. The time at which an incident task vⱼ is reported may be denoted as α(vⱼ) Incident tasks are assumed to be assigned after being reported. The delayed start penalty function decreases the utility value of tasks between the time of “task arrival” α(vⱼ) (i.e., time that incident was reported) and the time that work on the task starts, t(vⱼ). Consequently, δ may be represented as:

δ(vⱼ,tᵥⱼ)=β^{γ(t(v}^{ⱼ}^{)-α(v}^{ⱼ}⁾⁾ (6)

where β∈(0, 1 and γ≥1 are constants set according to the type of task.

For patrol work, there is no deadline, meaning no penalty of delay, so δ=1. When a new task arrives, agents can interrupt the performance of their current task, the current task (if any) denoted as CTi. A. That is, an officer handling a low importance task when a high importance incident is reported may stop what he is doing and attend to the high incident task. Agents do not return to interrupted tasks, though old tasks may be reported again as new tasks if further work is required. The symbol Aw represents the amount of work completed before a task is interrupted. Interruption of a task vⱼ incurs a penalty, π, which is a function of the total work to be done w(vⱼ) and the work done by the time the task is interrupted, Δw.

π(vⱼ,Δw)=max{I(vⱼ)cw(vⱼ)−Δw,ϕ·I(vⱼ)} (7)

cϵ[0; 1) and ϕ>0 are constants, preset to model an appropriate interruption penalty for a given tax, and ϕ·I(vj) is a preset minimum interruption penalty.

Travel time between a location of an agent and a location of an event task is given below as ρ, also given hereinbelow as ρ(v₁, v₂), where v₁ is a first task of the agent, and v₂ is a second task of an agent.

It can be noted that the total utility of an agent aᵢ, performing m portions of tasks (x₁, . . . xₘ) may be designated as

uᵢ(xᵢ, . . . ,xₘ)=Σⱼ₌₁^{m}uᵢⱼxᵢⱼ (8)

A term d_{q}^{vj} may denote the amount of time that q agents are working together on a task vⱼ. Then,

$$\frac{{qd}_{q}^{{v}_{j}}}{w ( {v}_{j} )}$$

is the relative part of the mission that is performed by q agents.

For a task requiring cooperation, a “task utility function” may be defined as an aggregate utility, that is, the sum of the utility of q agents working simultaneously. The “task utility function” may thus be defined by sums of the factors of agent utility, for each agent assigned to the task. These factors are the sum of agent contributions, times the delay penalty for the delay between arrival of the task and the start, minus the sum of interruption penalties for each agent leaving a previous task:

$$U ( {v}_{j} ) = {β}^{γ ( t ( {v}_{j} ) - α ( {v}_{j} ) ) } {\sum }_{q = 1}^{n} \frac{q {d}_{q}^{{v}_{j}}}{w ( {v}_{j} )} Cap ( {v}_{j} , q ) - \sum π ( {CT}_{i} , Δw ) \qquad ( 9 )$$

The parameters of the task utility function, including the forms of the functions Cap(vⱼ, q) and π(CTᵢ,Δw), as well as the terms, β, γ, w, are generally predefined for each task. The parameters of the task utility function are also parameters of an agent-task utility function, as described below. The value of the task utility function, like the agent-task utility function, can only be determined when the timing, the locations, and the interruption penalties of other tasks are known.

The “organization utility” of all agents performing all tasks vⱼ∈V is

U(V)=Σᵥ_{ⱼ}_{∈V}^{m}U(vⱼ) (10)

### Market-Clearing Solution

In a market clearing problem, n buyers each have different preferences for each of m goods. An n×m “preference matrix” R thus represents the preferences of each buyer, where each term of the preference matrix, rᵢⱼ, represents the relative preference that a buyer i has for a good j. The n×m “preference matrix” can also be viewed as a set of n “preference vectors”, each vector representing the preferences that a buyer i has for the m goods, that is, each vector has m “preference” terms.

A “Fisher market-clearing solution”, as described by Devanur et al. [3] is a simulated auction system whereby buyers are each “endowed” with units having bidding value, i.e., “money”. Buyers use the “money” to bid for the goods through an iterative auction process. At each stage of the process, the prices of the goods go up until all goods are sold and all money of all buyers is allocated. During the bidding process, each bidder bids so as to maximize a “bang-per-buck” (BPB), meaning maximizing the ratio of rᵢⱼ to the price of the good j for those bids. Buyers can bid for portions of goods. At the end of the auction, a price vector p is determined, that is, a vector in which each term, pⱼ, represents the price of each good j as set by the bidding process. The price vector is also referred to as the “market clearing vector” or the “equilibrium” market prices, because at the given prices all goods are “bought” and all money is spent.

A solution to the Fisher market clearing process is an n×m “market clearing” matrix X, where each entry 0≤xᵢⱼ≤1 is the fraction (i.e., portion) of each good j allocated to each buyer i, given the price vector p. A method for finding a price vector p in polynomial time is described by Devanur et al. [3], and a method for determining the market clearing vector X, given the vector p, is described by Reijnierse and Potters [5]. A pseudo-polynomial method, using a distributed algorithm of allocation, is described by Zhang [6].

In a centralized market clearing algorithm as described by Devanur et al. [3], the “simulated auction” uses a bipartite graph, G, where the vertexes of the graph are divided into two sets (A, B). The set B is the set of buyers, and A is the set of goods. An edge between buyer i∈B and goods j∈A exists if and only if it maximizes the “bang per buck” ratio for the buyer.

In order to compute an efficient allocation of goods, that is, an allocation in “equilibrium”, an optimization network is created as follows. Direct edges from A to B are assigned with a capacity of infinity. Direct edges from each source vertex s to each vertex j∈A are assigned with a capacity of pⱼ (that is, the current price of good j). Direct edges from sink vertex t to each vertex i∈B are assigned with a capacity of eᵢ (the endowment of buyer i). The network is a function of the current prices, p, and is denoted N(p). The algorithm starts with initial low prices and iteratively increases them. At each iteration, the algorithm ensures that at current prices all goods are sold, but buyers may be left with surplus money. It stops when all buyers expend their money, i.e., market clearing is achieved. In more detail, steps of the “simulated auction” are as follows:

1. Each buyer i first receives one unit of money, eᵢ=1. The initial prices are low enough to allow each buyer to afford all goods, i.e., pj=1/n. An N(p) network is constructed and an initial allocation is found by using a max-flow algorithm as described in Ford and Fulkerson [7], whose disclosure is incorporated herein, in its entirety.

2. At each iteration a maximum tight set is found. A tight set (A′,B′) comprises a set of buyers B′ and set of goods A′ that are assigned to them, that sustain the market clearing, i.e., the sum of the buyers' money in the set is equal to a sum of the goods' prices in the set. Therefore, the prices of goods in the set can be raised.

3. The algorithm raises the prices of goods in an active subgraph, which consists of a bipartition graph without vertexes in the tight set, i.e., (A-A′,B-B′). The prices of goods in the active subgraph are multiplied by a factor x.

4. The algorithm raises x, starting with x=1, until there is a new tight set inside the active subgraph or a new edge is added to the active subgraph. The new edge should hold the bang per buck property.

5. The algorithm stops when the tight set is equal to the original sets of buyers and goods, i.e., A′=A and B′=B. In this case the current prices are equilibrium prices and the max flow in the network between B and A is the equilibrium allocation.

The market clearing process may be implemented as a distributed process, such as a distributed proportional response algorithm as described by Zhang [6]. For each task there is a seller who computes the allocation for that task. Agents iteratively submit bids to sellers of the tasks within their “distance threshold” and are in turn awarded provisional allocations, which they use to modify their bids in the next round. This process converges in pseudo-polynomial time to an “approximate” market-clearing solution and allocation.

### Application of Market-Clearing to Task Assignment

In embodiments of the present invention, the market clearing algorithm is adapted to the problem of assigning tasks to agents. Instead of an allocation of goods among buyers, based on the preferences of the buyers, tasks are assigned to agents given the potential utility that each agent can contribute to the completion of all tasks. An n×m “agent-task utility” matrix R may be calculated, with each term of the matrix, rᵢⱼ representing not a “buyer preference”, but an “agent-task utility”, where the agent-task utility is an agent's potential contribution to the organization utility, which would result from the agent leaving a current task CTᵢ to perform a portion of a new task vⱼ. The rᵢⱼ term can be represented as follows:

rᵢⱼ=β^{γ(t(vj)-α(vj))}max_{q}{Cap(vⱼ,q)}−π(CTᵢ,Δw) (11)

The term rᵢⱼ as defined above is a function of three factors based on the parameters of the task utility functions: the delayed start penalty, which is itself a function of the new task and of the time required for the agent to travel from a prior task; the maximum contribution function, which sets the utility that the agent would generate by performing a share of the given task, assuming an optimal assignment of agents; and the interruption penalty function, which is a parameter of the current task performed by the agent (a term that is omitted if CTᵢ=vⱼ, that is, for continued performance of the current task). The term rᵢⱼ represents the utility of an agent aᵢ immediately moving to a task vⱼ and performing it with the optimal number of other agents. If an agent does not have a skill set required for a task, Cap(vⱼ, q) may be set to 0.

At a given moment of time, after a notification of a new incident is received, an “agent-task” utility value can be calculated for each term of the agent-task utility matrix. An “assignment” matrix X may then be determined by means of the Fisher market clearing algorithm, the algorithm being adapted to use the “agent-task utility” matrix, rather than a “buyer preference” matrix to assign tasks to agents. The “agent-task utility”, rᵢⱼ, is understood to be an approximation of the utility of an agent's work on a given task.

In a distributed processing implementation, the market clearing algorithm may be refined so that each agent is aware only of tasks within a certain threshold distance D (which may be defined by a distance or a travel time). That is, the agent-task utility function may be set to 0 for tasks outside of a certain threshold distance. Knowledge of the matrix R may be distributed among the agents (i.e., agent processors for a distributed algorithm) but each of the agents may be “aware” only of non-zero entries of the matrix.

### Concave Utility Function

For practical applications, the utility matrix R can be further refined by adjusting the terms rᵢⱼ to “encourage” sharing of tasks, that is, to assign higher utility to cooperation, by using a concave utility function. A concave function means that agents generate more utility by performing a first portion of a task than for a second portion. As a result, agents have less utility from performing all of a task independently and the market clearing algorithm increases the ratio of shared tasks to independently performed tasks.

In mathematical terms, the concave utility function, monotonically increasing for xᵢⱼ, may be defined as:

uᵢⱼ(xᵢⱼ):[0,1]→[0,rᵢⱼ] (12)

where xᵢⱼ is the amount of goods j allocated to buyer i, that is, the amount of task vⱼ assigned to agent aᵢ.

More specifically, the concave utility function may be defined as:

$${u}_{i j} ( {x}_{i j} ) = {( {h}_{i j} {x}_{i j} )}^{{μ}_{j}} \\ where {μ}_{j} ∈ ( 0 , 1 ] {h}_{i j} = {( {r}_{ij} )}^{\frac{1}{{μ}_{i}}} \qquad ( 13 )$$

The exponent, μⱼ, of the concave function can be defined as dependent on agent parameters, such as the distance (or travel time) of an agent from the task location. That is, the utility function may be binary, that is, either linear (μⱼ=1) when the agent distance is above a given threshold, or concave for a distance under the given threshold, μⱼ being set at a value greater than zero and less than 1. Such a heuristic allows the utility function to more closely approximate the utility that organizations attribute to agent cooperation on tasks. The concavity may also be determined by a utility ratio, the ratio being the utility of a shared task compared to all other tasks. A binary function may determine whether or not the utility function is concave, based on whether or not the utility ration is less than a given threshold. A further condition for concavity may be that if either of the distance or the utility ratio is less than their respective thresholds, then the utility function is concave, otherwise it is linear. Other conditions can also be employed when appropriate to approximate the utility of sharing tasks. The concavity may also be set differently for specific tasks, as warranted for the level of cooperation deemed appropriate for given tasks.

A “simulated auction” for achieving a market clearing solution incorporating concave buyer utility functions is described by Zhang [6]. In this algorithm, inputs to the Fisher market clearing mechanism are concave utility functions of the form uᵢⱼ(xᵢⱼ) where xᵢⱼ is the amount of goods j allocated to buyer i. Buyers place bids for the goods, each good being allocated to a buyer according to the proportion of the buyer's bid relative to the total bids placed on that good. The buyer submits bids in discrete time steps and adjusts his bids according to the utility received from each good in the previous time step. In the Zhang algorithm with concave utility functions, the price of each good is gradually adjusted according to the demand in the previous time step.

The algorithm described above may be implemented on distributed processors, each associated with an individual agent, each agent processor requiring data of the price vector and the rᵢⱼ terms for the individual agent aᵢ, rather than all terms of the agent-task utility matrix R. That is, for the distribution algorithm, each agent requires less than the total system information.

Formally, denoting a bid of buyer i on good j at time t as bᵢⱼ(t),

$${b}_{i j} ( t + 1 ) = \frac{{u}_{t j} ( L )}{{u}_{t} ( L )} {b}_{i j} where , \\ {u}_{i j} ( t ) = ( {w}_{i j} ) U ( V ) = {\sum }_{{v}_{j} ∈ V}^{m} U ( {v}_{j} ) \qquad ( 14 )$$

### Heterogeneous Model

As described above, tasks may require agents having heterogeneous skills. That is, tasks may be defined as requiring certain skill sets, and, in some cases, multiple skill sets. Each agent aᵢ may be defined as having a set of skills, Sᵢ, where Sᵢ ∈S, the total set of defined skills. For example, an agent may be qualified for both investigations and drug enforcement. A task, such as a drug-related incident, may require several agents with select skills, such as a drug enforcement agent and at least two special weapons and tactics (“SWAT”) agents.

Formally, an allocation of tasks to agents with heterogeneous skills may be denoted by an n×m×k matrix, X, where each entry xᵢⱼₛ of the matrix is the fraction of task vⱼ that is assigned to agent aᵢ, utilizing the skill s. An agent's schedule therefore may include, for each task being performed, a start time, an end time, and the skill s or skills that the agent is expected to apply. That is, a schedule for an agent may be:

σⁱ=(vₛ_{₁}_{ⁱ},s,t₁ⁱ,t₁ⁱ′), . . . ,(vₛ_{_{Mi}}_{ⁱ},s,t_{Mi}ⁱ,t_{Mi}ⁱ′) (15)

The capability function may be defined, in a heterogeneous model, for a vector \vec{q}∈N^{k} that specifies the number of agents with each skill working concurrently on a task, i.e., the l'th entry in \vec{q} represents the number of agents with skill sₗ working on the task concurrently.

For a simplification of the assignment problem, we may assume that each agent can be counted only once, i.e., an agent cannot utilize multiple skills simultaneously. Evaluating the function Cap(vⱼ, \vec{q}) gives a vector \vec{g} specifying for each skill the utility provided by an agent performing it, taking under consideration the number of agents performing the task.

A term

$${d}_{{q}^{->}}^{{v}_{j}}$$

may be denoted as the time that the set of \vec{q} agents are working together on a task vⱼ. Then

$$\frac{{d}_{{q}^{->}}^{vj}}{w ( {v}_{j} )}$$

is the relative part of the mission that is performed by the set of agents.

Denote by Q the total of all n sets of \vec{q} agents working on a task. The utility derived by the Q sets of agents for completing the task is (where q[l] and g[l] are the l'th entries in vectors \vec{q} and \vec{g} respectively):

$$U ( Q ) = {\sum }_{{q}^{->}}^{n} \frac{{d}_{{q}^{->}}^{vj}}{w ( {v}_{j} )} {\sum }_{l = 1}^{k} q [ l ] g [ l ] \qquad ( 16 )$$

When a new task arrives, the current task (if any) being performed by agent is denoted CTi and the current skill that is used by the agent is denoted CSi. The penalty for task interruption depends on the task and the amount of work for skill CSi completed at the time of interruption. The adjusted penalty for task vⱼ decreases exponentially with Δwⱼ^{CSi} to a minimum value and can be designated as

π(vⱼ,Δwⱼ^{CSi})=max{I(vⱼ)c^{wj}^{^{CS}}^{ᵢ}^{-wj}^{^{CS}}^{₁},ϕ·I(vⱼ)} (17)

The overall utility for completing a task, including penalties for late start and for interrupting other tasks is:

$$U ( {v}_{j} ) = {β}^{γ ( t ( {v}_{j} ) - α ( {v}_{j} ) )} {\sum }_{{q}^{->} ∈ Q} \frac{{qd}_{q}^{v j}}{w ( {v}_{j} )} \sum q [ l ] g [ l ] ) - \sum π ( C {T}_{i} , Δ {w}_{j}^{C S i} ) \qquad ( 18 )$$

To solve the market clearing problem for heterogeneous agents, the agent-task utility matrix R may be defined with three dimensions, like the allocation matrix, that is, an n×m×k matrix, where each entry rᵢⱼₛ is the utility of a given agent applying a given skill to a given task vⱼ. An equation for rᵢⱼₛ may be represented as:

rᵢⱼβ^{γ(t(vj)-α(vj))}max_{\vec{q}}{Cap(vⱼ,\vec{q})}−π(CTᵢ,Δwⱼ^{CSi}) (19)

The matrix may be simplified to conform to the market clearing algorithms described above by a transformation of the three dimensional matrix to a two dimensional matrix. The transformation establishes each skill required for each task as a separate “skill-based task” vⱼₛ. The process of the simulated auction, as described above, then assigns skill-based tasks to agents.

### Ordering of Tasks

The Fisher market clearing process models the distribution of goods and consequently the result of the process is an unordered list of goods acquired. To generate agent schedules from unordered lists of tasks, a scheduling stage of the heuristic process, that is, a “scheduling process” is required.

The scheduling process includes two general steps. The first is to calculate a utility ranking for each task assigned to each agent. One type of utility ranking that may be applied is a “bang per buck” (BPB) ratio, this being the ratio of a utility of performing a task to the time spent on the task. For each skill-based task vⱼₛ, as described above, where xᵢⱼₛ is the portion of the skill-based task assigned to the agent, a BPB ratio may be calculated as follows:

$$\frac{{r}_{ijs} {x}_{ijs}}{w ( {ν}_{j s} ) {x}_{i j s} + ρ ( {a}_{i} , {ν}_{j} )} \qquad ( 20 )$$

the term rᵢⱼₛxᵢⱼₛ is the utility an agent provides by performing his portion of task vⱼₛ and the term [w(vⱼₛ)xᵢⱼₛ+ρ(aᵢ, vⱼ)] is the time that the agent works on vⱼₛ, the time being composed of travel time to the task and the actual time working on the task.

After calculating the BPB ratio for each of the tasks assigned to an agent, tasks may be sorted in descending order according to this ratio. Other sorting orders may also be calculated based on other definitions of utility, as described further hereinbelow.

If inter-task constraints are defined, that is, different skill-based subtasks of a single task are defined as requiring a sequential order of implementation, then the ordering established by the BPB ratio must first be modified to suit the sequential requirement. Next, the start times of tasks must be updated to reflect the inter-agent constraints for shared tasks that are defined as requiring simultaneous arrival of agents. This may not be the case for all tasks. To coordinate the timing of share tasks, non-shared tasks may be delayed. Alternatively, if a shared task requiring simultaneous arrival cannot be coordinated at an earlier time, such that an agent may have a time gap between assigned tasks, some non-shared tasks may be scheduled earlier, as long as those tasks don't interfere with the agent's arrival for the next shared task.

Ordering assigned tasks may be done according to the BPB ratio defined above or by other methods of ordering that may provide results appropriate for a given organization, such as a police force. Alternative methods of ordering may include the following:

Max rᵢⱼₛ: Ordering tasks according to agent-task utility values, that is, according to the rᵢⱼₛ entries of the R matrix. Tasks with high rᵢⱼₛ values are scheduled first. The rᵢⱼ entries represent the maximum group benefit from performing a task, assuming all agents required for a task are assigned.

Max rᵢⱼxᵢⱼ: Ordering tasks according to the utility of an agent's performance of a task, but without normalizing the utility value according to the time allocated to the task, in contrast to the “bang for buck” ranking.

Max I(vj), Min α(vj): Tasks are ordered first by task importance I(vj), such that urgent events get handled first (e.g., murder or robbery), even if an agent has more “bang per buck” elsewhere. If more than one event of the same importance is allocated to an agent, the agent schedules the one that was reported first.

Max I(vj), Max α(vj): Tasks are ordered first by task importance I(vj), and if more than one event has the same importance, the most recent event is scheduled first.

After agents' initial assignment lists are established by the market clearing process, individual schedules can be optimized by moving tasks delayed by shared tasks earlier in the order without further delaying shared tasks. For a shared task vₛ_{ₖ}_{ⁱ} with k>1 and non-shared task vₛ_{ₖ₊₁}_{ⁱ}k>1 the non-shared task is moved before the shared task if

tₛ_{ₖ}_{ⁱ}≥tₛ_{_{k−1}}_{ⁱ}+ρ(vₛ_{_{k−1}}_{ⁱ},vₛ_{ₖ₊₁}_{ⁱ})+xₛ_{ₖ₊₁}_{ⁱ}w(vₛ_{ₖ₊₁}_{ⁱ})+ρ(vₛ_{ₖ₊₁}_{ⁱ},vₛ_{ₖ}_{ⁱ}) (21)

If k=1 (the shared task is first) at time t, the non-shared task is moved if

τₛ_{ₖ}_{ⁱ}≥t+xᵢₛ_{₂}_{ⁱ}w(vₛ_{₂}_{ⁱ})+2ρ(aᵢ,vₛ_{ₖ}_{ⁱ}) (22)

Each task is considered once, requiring O(m) time.

For distributed processing, for each task vⱼ=vₛ_{ₖ}_{ⁱ} allocated to it, agent aᵢ maintains an estimated start time tᵥ_{ⱼ}ⁱ initialized to tₖⁱ, where,

tᵥⱼ=max{tₖⁱ|vₛ_{ₖ}_{ⁱ}=vⱼ∧xᵥⱼ>0} (23)

tₖⁱ=max{tₖ₋₁ⁱ+ρ(vₛ_{ₖ}_{ⁱ},vₛ_{ₖ₊₁}_{ⁱ}),tₛ_{ₖ}_{ⁱ}} (24)

For each shared task, vⱼ, agent aᵢ communicates a message (tᵥ_{ⱼ}ⁱ, vⱼ) to all other agents with whom it shares the task. It should be noted that this is only done for shared tasks that are defined as requiring a shared arrival time. Also, some shared tasks require that all agents with all skills for the task arrive at the same time. In other cases, only agents with similar skills need to coordinate arrival times.

Coordinating the arrival time for a shared task may include sending from each agent to every other agent assigned to the shared task a message with an earliest time of arrival; and determining by each agent a shared time as the last earliest time of arrival.

In mathematical terms, upon receiving a (tᵥ_{ⱼ}ⁱ, vⱼ) message, where vⱼ=vₛ_{ₖ}_{ⁱ}, agent aᵢ computes the change in time θ=tᵥⱼ−tᵥ_{ⱼ}ⁱ. If θ>0, then for all k′≥k, agent aᵢ adds θ to t_{k′}ⁱ and transmits the new values (t_{k′}ⁱ, vₛ_{ₖ}_{ⁱ}) to all agents sharing vₛ_{ₖ}_{ⁱ}.

The ordering process terminates in polynomial time with tᵥⱼ=tᵥ_{ⱼ}ⁱ=tᵥ_{ⱼ}^{i′} for all aᵢ, aᵢ∈A, vⱼ∈V. At least one time tᵥ_{ⱼ}ⁱ will become permanently fixed in each synchronous communication cycle, and so the number of communication cycles is bounded from above by the total number of tasks in the schedules. Each schedule can contain at most m tasks and there are n schedules, so the number of communication cycles is bounded by inn. The first stage of the allocation and scheduling heuristic, that is, the simulated auction process, also executes in polynomial time; consequently, the execution of the two stages (both the allocation, i.e., market clearing, and the scheduling stages) is performed in polynomial time.

### Flowchart of Task Allocation and Scheduling Process

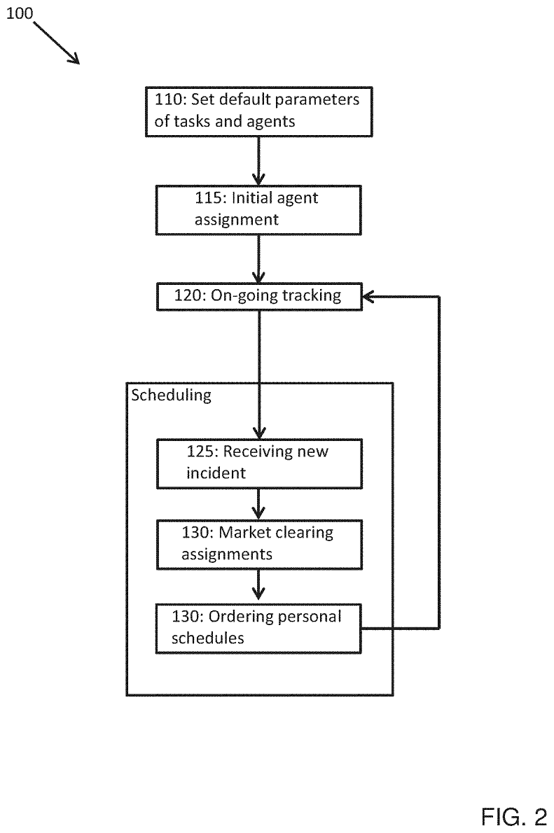

FIG. 2 shows a flowchart of a process 100 for real-time scheduling of tasks, in accordance with an embodiment of the present invention. At a configuration step 110, parameters of tasks are defined, as described above. That is, generic tasks are defined, including importance ratings, utility functions, delay penalties, and interruption penalties. Skills sets may also be defined for generic tasks. Geographic zones may also be defined, setting areas for patrols and limits on assignment distances that may be used to assign agents during the subsequent assignment step. At the configuration step, agents available may also be defined, as well as agent skills.

At a pre-scheduling step 115, initial agent assignments may be made, based on pre-defined schedules. This step presumes that no incidents are yet reported, and that agents are therefore assigned to pre-scheduled tasks, such as patrols.

Subsequently, at a tracking step 120, locations of agents and tasks are tracked by the server. As each agent (or unit) finishes a task, they continue at the next scheduled task until the system receives a new incident requiring rescheduling.

At an incident reporting step 125, the server receives (typically through the hot-line center) a report of a new incident, at a given location, and an operator designates a generic type of task to represent the reported incident. Operators may make changes as necessary to the parameters of the generic tasks, such as changing the expected workload and/or types of required skills.

At a task reassignment step 130, task assignments are made by means of a market clearing algorithm. As described above, the process may be a distributed process or a centralized process performed by the server.

Subsequently, at a scheduling step 135, the schedule of the allocated tasks for each agent is generated, first ranking the assigned tasks for each agent according to a utility ranking and then changing the order to coordinate start times of shared tasks performed by teams. The scheduling may also be a distributed process or a centralized process, as described above. For the distributed process, performed by mobile devices 28 associated with each agent in the field, agents may begin working according to the new schedules as soon as they are generated. For the centralized process, the server 26 may directly notify the agents 22 of their schedules, by communication with the mobile devices 28 or through the dispatch or “hot-line” center 30.

After agents receive their new schedules, the process 100 reiterates from the tracking step 120, such that the process may be continued indefinitely.

Devices performing processing tasks of system 10 and of process 100 and of other derived embodiments of the present invention can be implemented by a processor, meaning any one or more microprocessors, central processing units (CPUs), computing devices, microcontrollers, digital signal processors, FPGA or like devices. Data storage media, or computer-readable media, may refer to any non-transitory medium that participates in providing data (e.g., instructions) that may be read by a processor. Such a medium may take many forms, including but not limited to, non-volatile and volatile media. Sequences of instructions may be delivered (i) from RAM to a processor, (ii) over a wireless transmission medium, and/or (iii) may be formatted according to numerous formats, standards or protocols, such as Bluetooth, TDMA, CDMA, and 3G. Formats described for storing data, such as data dictionaries and databases, may include other formats, including tables, relational databases, object-based models and/or distributed databases. In addition, the data may be stored locally or remotely from a device which accesses the data. For example, in some embodiments, the database 34 may operate from a cloud platform communicating over the internet with the server and/or the mobile devices. Software may be deployed to be executed on multiple computers at one site or distributed across multiple sites. Network interface modules may control the sending and receiving of data packets over networks.

Method steps associated with the system and process can be rearranged and/or one or more such steps can be omitted to achieve the same, or similar, results to those described herein. It is to be understood that the embodiments described hereinabove are cited by way of example, and that the present invention is not limited to what has been particularly shown and described hereinabove. Rather, the scope of the present invention includes variations and modifications thereof which would occur to persons skilled in the art upon reading the foregoing description and which are not disclosed in the prior art. Changes and modifications, which do not depart from the teachings of the present invention, will be evident to those skilled in the art. Such changes and modifications are within the purview of the present invention and the appended claims.

### REFERENCES

[1] S. Amador, S. Okamoto, R. Zivan, “Dynamic multi-agent task allocation with spatial and temporal constraints”, AAMAS '14, Proceedings of the 2014 International Conference on Autonomous Agents and Multi-Agent Systems, pp. 1495-1496.
[2] William C Brainard, Herbert E Scarf, et al. “How to compute equilibrium prices in 1891.” 2000.
[3] N. R. Devanur et al. “Market Equilibrium via a Primal-Dual-Type Algorithm”, FOCS 2002: Proceedings of the 43rd Symposium on Foundations of Computer Science. Washington, D.C., USA, 2002, pp. 389-395.
[4] D. Gale. The Theory of Linear Economic Models, McGraw-Hill, 1960.
[5] J. H. Reijnierse and J. A. M. Potters. “On finding an envy-free Pareto-optimal division”, Mathematical Programming 83 (1998), pp. 291-311.
[6] L. Zhang. “Proportional response dynamics in the Fisher market”, Theoretical Computer Science 412.24 (2011), pp. 2691-2698.
[7] Ford, L. R. and D. R. Fulkerson. “Flows in Networks”, 1962.

1. A computing system, having at least one processor and at least one memory storage, the memory storage communicatively coupled to the processor, on which is stored computer-readable instructions that when executed by the processor cause the computing system to perform a method for allocation and scheduling of tasks comprising:
receiving an agent list, wherein each agent is associated with a first geographic location and with a skill set;
receiving a task list, wherein each task is associated with one or more skill requirements, a second geographic location, and parameters of a task utility function;
assigning to each agent a plurality of tasks from the task list, by a simulated auction process comprising calculating agent-task utility values, wherein the agent-task utility values are calculated from the parameters of the task utility functions, including a delayed start penalty, a task interruption penalty, and an agent contribution function;
generating a schedule of the assigned plurality of tasks for each agent, by ranking the assigned plurality of tasks according to a utility ranking; and
changing an order of assigned tasks of a schedule of at least one agent, to coordinate a start time of a shared task performed by multiple agents.

2. The computing system of claim 1, wherein assigning to each agent the plurality of tasks comprises assigning a given task to a given agent only if the skill set of the given agent includes a required skill of the given task.

3. The computing system of claim 1, wherein the utility ranking, for a given task assigned to a given agent, equals an agent-task utility value, for the given task assigned to the given agent, divided by the given agent's portion of a workload of the given task.

4. The computing system of claim 1, wherein the delayed start penalty is a function of a difference between a start time of a given task and a time that a notification of the task was received by the computing system.

5. The computing system of claim 1, wherein the task interruption penalty of an agent utility is a function of a predefined interruption penalty factor of a current task and an amount of work performed by the given agent.

6. The computing system of claim 1, wherein the contribution function is the maximum contribution a given agent provides to the utility of a given task, assuming an optimal assignment of agents to the given task.

7. The computing system of claim 1, wherein changing an order of assigned tasks of the schedule of the at least one agent comprises a distributed process, the distributed process comprising sending from each of the multiple agents to each of the other multiple agents a notification of an earliest time of arrival to the shared task; and wherein each of the multiple agents determines the start time for the shared task as the latest time of all the earliest times.

8. The computing system of claim 1, wherein the method for allocation and scheduling of tasks executes in polynomial time.

9. The computing system of claim 1, wherein the agent-task utility values are determined by concave, exponential functions, wherein the exponents of the functions are greater than 0 and less than 1, such that the simulated auction assigns more shared tasks to the agents than when the agent-task utility values are determined by linear functions.

10. The computing system of claim 9, wherein the exponent is set according to a need for cooperation on a task.

11. A computer-based method for allocating and scheduling tasks, implemented by at least one processor having at least one memory storage on which is stored computer-readable instructions, which, when executed by the processor, cause the computing system to perform the method comprising:
receiving an agent list, wherein each agent is associated with a first geographic location and with a skill set;
receiving a task list, wherein each task is associated with one or more skill requirements, a second geographic location, and parameters of a task utility function;
assigning to each agent a plurality of tasks from the task list, by a simulated auction process comprising calculating an agent-task utility value, wherein the agent-task utility values are calculated from the parameters of the task utility functions, including a delayed start penalty, a task interruption penalty, and an agent contribution function;
generating a schedule of the assigned plurality of tasks for each agent, by ranking the assigned plurality of tasks according to a utility ranking; and
changing an order of assigned tasks of a schedule of at least one agent, to coordinate a start time of a shared task performed by multiple agents.
